(19) United States
(12) Patent Application Publication
(10) Pub. No.: US 2013/0271014 A1
(43) Pub. Date: Oct. 17, 2013

(54) Internally Illuminated Pavement Marker

(71) Applicants: Ramya S. Dasaratha, Bangalore (IN); Shrey Gupta, Bangalore (IN); Amit V. Rao, Bangalore (IN)

(72) Inventors: Ramya S. Dasaratha, Bangalore (IN); Shrey Gupta, Bangalore (IN); Amit V. Rao, Bangalore (IN)

(73) Assignee: 3M INNOVATIVE PROPERTIES COMPANY, St. Paul, MN (US)

(21) Appl. No.: 13/884,629

(22) PCT Filed: Nov. 8, 2011
(86) PCT No.: PCT/US2011/059705

§ 371 Date: Jul. 1, 2013

(30) Foreign Application Priority Data
Nov. 16, 2010 (IN) 2010/3445

(51) Int. Cl. F21S 8/00; F21S 9/03; H05B 33/08

(52) U.S. Cl. CPC F21S 8/032; H05B 33/0854; F21S 9/035
USPC 315/158; 362/557; 362/555

(57) ABSTRACT

The present disclosure generally relates to internally illuminated pavement markers that may be attached to or installed into a roadway surface to enhance traffic delineation, such as, for example, traffic lane skip lines and edge lines and include at least some of the following elements: a light source capable of emitting light; a power source; a solar energy system capable of collecting solar energy and converting the solar energy into electrical energy, the solar energy system conductively coupled to the rechargeable electrical power source such that the solar energy collected and converted into electrical energy is capable of recharging the power source; an optical light guide capable of propagating the light emitted by the light source within the pavement marker by means of total internal reflection; and a housing including at least one of the light source, the power source, the solar energy system, and/or the optical light guide.

### FIELD OF THE INVENTION

The present disclosure generally relates to pavement markers capable of use for traffic markings and delineation. More particularly, the present disclosure relates to internally illuminated pavement markers.

### BACKGROUND OF THE INVENTION

Raised pavement markers (RPMs) are widely used as highway traffic markings for providing road lane delineation. Typically, RPMs include a retroreflective lens attached to a marker body. The retroreflective lens generally returns light directly back to its source and consequently appears brightest to observers positioned near the light source. Conventional RPMs have the disadvantage of only being visible when light from, for example, an oncoming vehicle is directed toward the raised pavement marker and impinges on the retroreflective lens.

### PRIOR ART

Internally illuminated raised pavement markers, such as, for example, those described in U.S. Pat. No. 4,668,120 (Roberts) and U.S. Pat. No. 5,984,570 (Parashar), allow the raised pavement marker to be clearly visible to motorists over an extended distance, beyond the range of a vehicle's headlamp. This feature is especially important in low-lit areas or areas that demand a high level of driver attention, such as, for example, sharp curves.

However, conventional RPMs include a focused point light source. For example, U.S. Pat. No. 4,668,120 (Roberts) relates to a self-contained solar-powered pavement marker comprising at least one light source and an optical lightguide and fresnel lens that focus the light from the light source into a single point. Also, PCT Publication No. WO 00/63730 (Couzin) relates to a pavement marker that uses a focused LED to provide maximum illuminance to an oncoming vehicle. PCT Publication No. WO 01/31125 (Flader) relates to a reflective pavement marker comprising at least one LED which emits a beam of light visible to the driver, and beam shaping optics capable of modifying the LED beam from an approximately circular beam shape to a substantially non-circular beam shape having a maximum height and a maximum width, such that the maximum width is greater than the maximum height. If the focused light and/or LED is directed at oncoming traffic, the high luminance output of the LED may distract or temporarily “blind” the motorist. Also, the focused light does not allow the RPM to be seen from all directions.

### SUMMARY OF THE INVENTION

The present inventors recognized the need for an internally illuminated raised pavement marker. Specifically, the present inventors recognized the need for an internally illuminated raised pavement marker that provides adequate diffuse luminance to be visible from a distance while reducing the number of light sources. The present inventors also recognized the need for an internally illuminated raised pavement marker that may be seen from all directions.

The present disclosure relates to a self-illuminating pavement marker including at least some of the following elements: (1) a light source capable of emitting light; (2) a power source; (3) a solar energy system capable of collecting solar energy and converting the solar energy into electrical energy, the solar energy system conductively coupled to the rechargeable electrical power source such that the solar energy collected and converted into electrical energy is capable of recharging the power source; (4) an optical lightguide capable of propagating the light emitted by the light source within the pavement marker by means of total internal reflection; and (5) a housing including at least one of the light source, the power source, the solar energy system, and/or the optical lightguide. In embodiments where the pavement marker includes a solar energy system, at least a portion of the housing is preferably transparent such that sunlight can pass through the transparent portion of the housing and charge the solar cell. A housing with a transparent portion may also be preferred in embodiments that do not include a solar energy system to permit exit of the light emitted by the light source.

The present disclosure generally relates to a self-illuminating pavement marker, comprising: a light source capable of emitting light, the light source conductively coupled to a rechargeable electrical power source; a solar energy system capable of collecting solar energy and converting the solar energy into electrical energy, the solar energy system including a solar cell and being conductively coupled to the rechargeable electrical power source such that the solar energy collected and converted into electrical energy recharges the rechargeable electrical power source; an optical fiber capable of propagating the light emitted by the light source within the pavement marker by means of total internal reflection; and a housing including at least one of the light source, the solar energy system, and the optical fiber, at least a portion of the housing being transparent such that ambient light can pass through the transparent portion of the housing and charge the solar cell and out of which the light emitted by the light source can propagate.

In some embodiments of the self-illuminating pavement marker, the light source includes at least one LED. In some embodiments of the self-illuminating pavement marker, the light source is a single LED. Some embodiments of the self-illuminating pavement marker further includes a retroreflective element. In some embodiments, the self-illuminating pavement marker includes a solar energy system including a circuit board containing a solar charging circuit, a light sensor circuit, and a light source driver circuit capable of applying power to the light source when the amount of ambient light falls below a predetermined threshold. In some embodiments of the self-illuminating pavement marker, the predetermined threshold is the point at which ambient light is insufficient to power the light source. In some embodiments of the self-illuminating pavement marker, the light source driver circuit is capable of using power from the light source to charge the rechargeable electrical power source when the ambient light exceeds the predetermined threshold. In some embodiments of the self-illuminating pavement marker, the housing includes detachable portions. In some embodiments of the self-illuminating pavement marker, the optical fiber has a light emitting region and includes a plurality of optical elements comprising optical quality reflecting surfaces that are arranged such that light propagating along the optical fiber impinges upon the optical quality reflecting surfaces. In some embodiments of the self-illuminating pavement marker, at least one of the optical quality reflecting surfaces has a cross-sectional area that is less than that of the optical fiber. In some embodiments of the self-illuminating pavement marker, the optical quality reflecting surfaces vary in at least one of cross-sectional area and spacing such that the light emitted at the light emitting region is substantially uniform.

The present disclosure also generally relates to a self-illuminating pavement marker, comprising: a single LED capable of emitting light and connected to a power source; an optical fiber capable of propagating the light emitted by the LED within the pavement marker by means of total internal reflection; a retroreflective element; and a housing within which are located at least one of the light source, the power source, and the optical fiber.

In some embodiments of the self-illuminating pavement marker, the power source is a rechargeable electrical power source and further includes: a solar energy system capable of collecting solar energy and converting the solar energy into electrical energy, the solar energy system including a solar cell and being conductively coupled to the rechargeable electrical power source such that the solar energy collected and converted into electrical energy recharges the rechargeable electrical power source.

In some embodiments of the self-illuminating pavement marker, the solar energy system includes a circuit board containing a solar charging circuit, a light sensor circuit, and a light source driver circuit capable of applying power to the light source when the amount of ambient light falls below a predetermined threshold.

In some embodiments of the self-illuminating pavement marker, the predetermined threshold is the point at which ambient light is insufficient to power the light source.

In some embodiments of the self-illuminating pavement marker, the light source driver circuit is capable of using power from the light source to charge the rechargeable electrical power source when the ambient light exceeds the predetermined threshold.

In some embodiments of the self-illuminating pavement marker, the housing includes detachable portions.

In some embodiments of the self-illuminating pavement marker, the optical fiber has a light emitting region and includes a plurality of optical elements comprising optical quality reflecting surfaces that are arranged such that light propagating along the optical fiber impinges upon the optical quality reflecting surfaces.

In some embodiments of the self-illuminating pavement marker, at least one of the optical quality reflecting surfaces has a cross-sectional area that is less than that of the optical fiber.

In some embodiments of the self-illuminating pavement marker, the optical quality reflecting surfaces vary in at least one of cross-sectional area and spacing such that the light emitted at the light emitting region is substantially uniform.

### BRIEF DESCRIPTION OF ACCOMPANYING FIGURES

FIG. 1 is a circuit diagram of an exemplary circuit for use in an internally illuminated raised pavement marker according to the present disclosure.

FIG. 2 is a perspective view of an exemplary internally illuminated raised pavement marker according to the present disclosure.

FIG. 3 is a perspective view of another exemplary internally illuminated raised pavement marker according to the present disclosure.

### DETAILED DESCRIPTION OF THE INVENTION

The present disclosure generally relates to internally illuminated pavement markers that may be attached to or installed into a roadway surface to enhance traffic delineation, such as, for example, traffic lane skip lines and edge lines. The internally illuminated pavement markers of the present disclosure may be of any appropriate form, shape, or size. Some exemplary shapes include square, round, oblong, elliptical, rectangular, octagonal, and pentagonal.

The present disclosure relates to various embodiments of self-illuminating pavement markers including at least some of the following elements: (1) a light source capable of emitting light; (2) a power source; (3) a solar energy system capable of collecting solar energy and converting the solar energy into electrical energy, the solar energy system conductively coupled to the rechargeable electrical power source such that the solar energy collected and converted into electrical energy is capable of recharging the power source; (4) an optical light guide capable of propagating the light emitted by the light source within the pavement marker by means of total internal reflection; and (5) a housing including at least one of the light source, the power source, the solar energy system, and/or the optical light guide. Each of the portions of the self-illuminating pavement marker is discussed in greater detail below;

The self-illuminating pavement marker includes a light source. Any light source may be used. Some exemplary light sources include a single LED, multiple LEDs, one or more white LEDs, and one or more red LEDs. In some exemplary embodiments, a single light source is preferred.

The self-illuminating pavement marker includes a power source. In some embodiments, the power source is a battery. Any type of battery may be used. In some embodiments, the power source is a rechargeable power source. For example, a rechargeable electrical power source may be used. Some exemplary rechargeable electrical power sources include nickel metal hydride, nickel-cadmium, and lithium ion batteries.

Some embodiments include an optional second (backup) power source or battery connected in parallel with a primary power source or battery. Such embodiments may ensure that the power source has ample charge to power the light source at night even when the solar energy system has not been exposed to sufficient ambient light to power the pavement marker.

Some embodiments of the internally illuminated pavement markers include a solar energy system including a solar cell that charges a rechargeable power source during periods of ambient light (e.g., daytime). These pavement markers then use the recharged power source to power a light source that illuminates the pavement marker during periods of low ambient light (e.g., night time). The net effect is that the solar energy unit and rechargeable power source work in combination to automatically turn the power to the light source off during the day and on at night, effectively allowing the device to charge all day and illuminate all night.

In embodiments where the self-illuminating pavement marker includes a solar energy system, the solar panels or cells generate power when ambient light levels are high. This power is used to charge the rechargeable electrical power source by converting ambient light (e.g., sunlight) into electrical energy. Power from the rechargeable electrical power source is then used to power the light source.

Some embodiments of the self-illuminating pavement markers include an optical fiber or light guide. As used herein, an optical fiber is a thin, flexible, transparent fiber that acts as a waveguide or “light pipe” to transmit light, via total internal reflection, between the two ends of the fiber. In some embodiments, an optical fiber includes a transparent core surrounded by a transparent cladding material with a lower index of refraction.

In some preferred embodiments, the optical fiber facilitates substantially uniform and/or diffuse emission of light through the emitting region of the housing. One exemplary way to effect this uniformity of light is to use an optical fiber including a plurality of optical elements spaced along the optical fiber. The term “optical element” is used herein to encompass any controlled interruption or discontinuity formed in the core of the optical fiber, which defines one or more surfaces capable of reflecting at least a portion of light impinging thereon through the opposing wall of the optical fiber. The optical elements include at least one reflecting surface arranged such that a portion of the light propagated through the optical fiber and impinging upon the surface(s) of an optical element is reflected across the optical fiber and through the wall of the light emitting region. More information on optical fibers including optical elements can be found, for example, in U.S. Pat. No. 5,432,876 (Appeldorn), incorporated herein by reference. Also, one exemplary commercially available optical fiber that includes optical elements is the Precision Lighting Element sold by 3M Company.

In some embodiments, the optical fiber includes a light emitting region having reflecting surfaces, at least one of which has a cross sectional area that is less than the cross-sectional area of the fiber. In other embodiments, the optical fiber propagates light in a preselected direction. In some embodiments, the self-illuminating pavement marker includes a thin profile lighting film that disperses light emitted by the light source. The thin profile lighting film can be in addition to or instead of the optical fiber. Exemplary thin profile lighting films include those sold by 3M Company.

Some embodiments of the self-illuminating pavement markers of the present disclosure include an electric circuit connecting the light source and the power source. In embodiments including a solar energy system, the electric circuit will also connect the solar cell. Those of skill in the art will appreciate that many different circuit constructions may be used. As such, the specific circuits shown and discussed herein are merely exemplary.

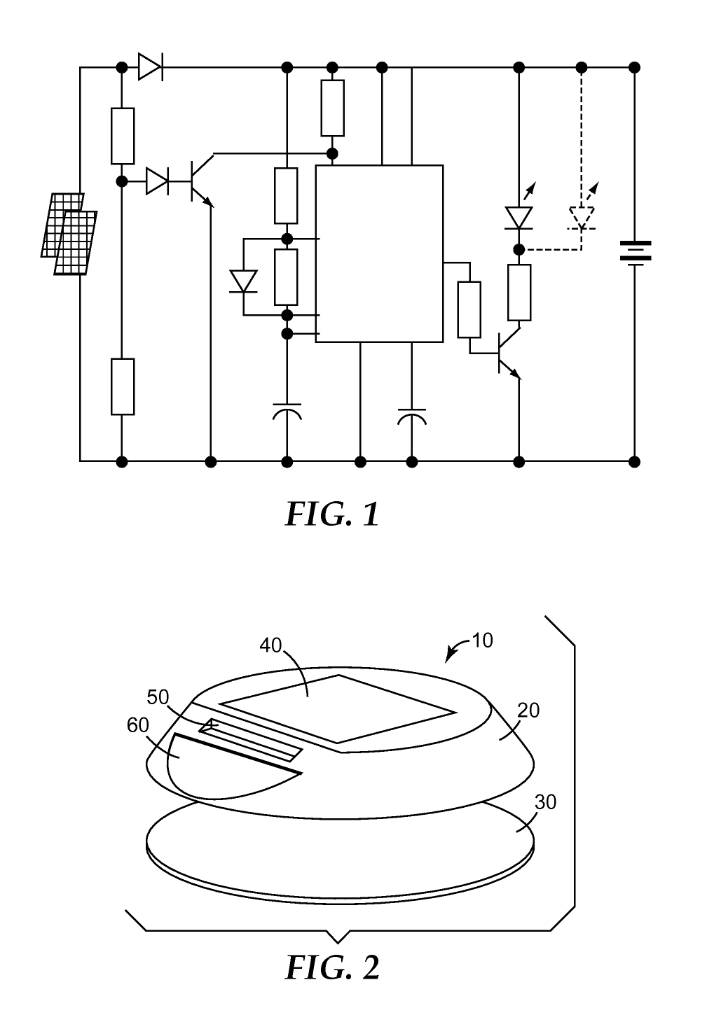

One specific circuit construction will be shown and discussed herein (see FIG. 1). This exemplary circuit relates to an internally illuminated pavement marker including a solar energy system. The electric circuit includes a circuit board with a solar charging circuit, light sensor circuit, and light source driver circuit. In some embodiments, the light sensor circuit triggers the LED driver to apply power to the LED only at night or whenever there a reduced amount of ambient light, thereby conserving power. In other embodiments, when the ambient lights drops below a threshold level (e.g., nighttime or cloudy days or any predetermined level), the light sensor activates the circuit. The circuit may include, as is known, a light sensitive switch that automatically turns off the power source during daylight hours. In some embodiments, the circuit includes a programmed timer to turn the light source on or off during normal use. Some embodiments include a built-in timer circuit that turns the light source ON and OFF for chosen periods of time. For example, one exemplary timer circuit automatically activates the light source at dusk and deactivates it at dawn. In some exemplary embodiments, the pavement markers are illuminated during the day without any charging where a nonrechargeable power source(s) is/are used.

The self-illuminating pavement marker of the present disclosure includes a structurally sound housing inside of which is at least one of the light source, the power source, the rechargeable power source, the solar energy system, and/or the optical fiber. In some embodiments, the housing is fully-enclosed, molded, watertight, airtight, abrasion resistant, and/or crack-resistant.

Three exemplary housing embodiments are shown in FIGS. 2, 3 and 4. Housing 10 includes a top shell portion 20 and a bottom shell portion 30. As shown in the specific implementation of FIG. 2, top shell portion 20 is a molded, concave, open-faced structure bounded by peripheral sidewalls the terminal ends of which are capable of mating with portions of bottom shell portion 30. Top and bottoms shell portions 20 and 30 can be held together in any way known in the art, including, for example, by mechanical means (e.g., one or more screws, nail, rivets, and/or gaskets), adhesive means (e.g., adhesives, adhesive tapes, and/or adhesive films), and welding (e.g., ultrasonic welding). Top and bottom shell portions 20 and 30 may be detachable or non-detachable. Detachable housing portions may be preferred in situations where the housing 10 will have to be opened. One exemplary housing can be detached by detaching top shell portion 20 from bottom shell portion 30, for example, when or if the power source requires replacement. In some embodiments, top shell portion 20 and bottom shell portion 30 are of the same approximate peripheral dimensions to ensure accurate attachment and detachment. In some embodiments, at least a portion of top shell portion 20 is transparent. Inclusion of a transparent portion of housing 10 may, for example, permit incidence of ambient light (e.g., sunlight) into/onto a solar panel (where present) or exit of light emitted by the light source from the internally illuminated pavement marker.

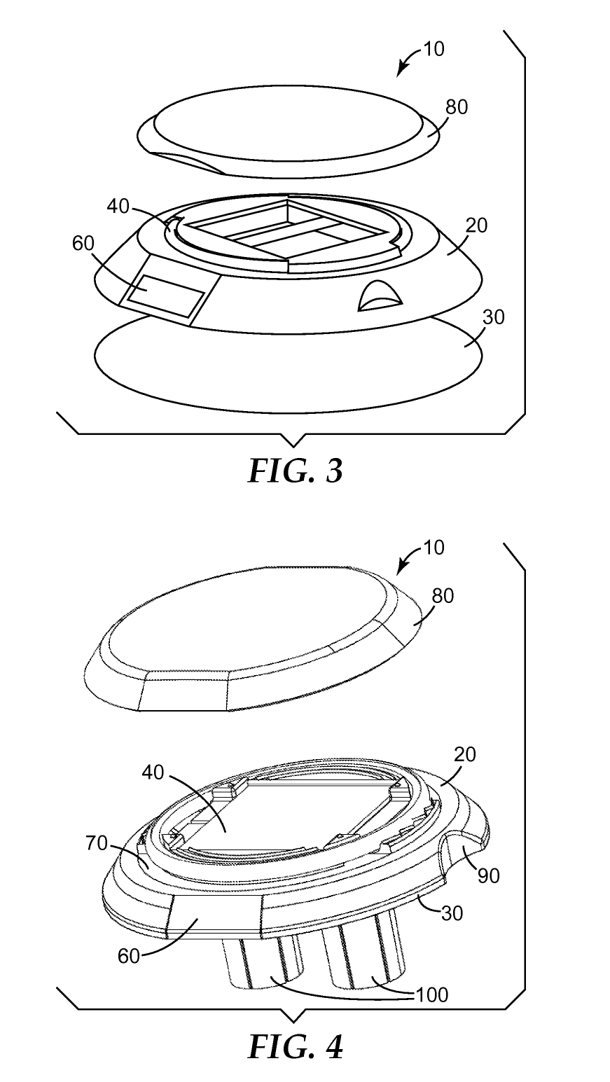

In some embodiments, top shell portion 20 includes one or more solar panels or cells 40. As shown in the specific implementation of FIGS. 2, 3 and 4, solar panel 40 forms a rectangular area on the flat, uppermost portion of top shell portion 20. Top shell portion 20 may also include a lens array that focuses ambient light on the solar cells, even when the sun is not directly vertically above top shell portion 20. Also, a lens array can diffuse light emanating from the light source to provide a more attractive and diffused illumination. As shown in FIGS. 3 and 4, top shell portion 20 can also include a transparent overlay portion 80 and an optical fiber 70. In some embodiments, top shell portion 20 also includes an opening or aperture 50 through which light emitted by the optical fiber exits. Some exemplary embodiments include one or more finger grips 90 that are used to install the pavement marker.

In some embodiments, Housing 10 includes single or a plurality of shanks (100) as shown in FIG. 4. Shanks (100) are used to adhere the pavement marker to the road by any appropriate means such as drilling, curing with epoxy etc. In some embodiments shanks (100) can also be used to house batteries or a source of power supply for the electric circuit.

Housing 10 can be made of any appropriate material and by any known process. Exemplary materials include, for example, thermoplastic resin (e.g., polycarbonate, polyethylene, or polypropylene), a fiber reinforced material (e.g., as described in U.S. Pat. No. 5,667,335 (Khieu)), a curable composition (e.g., urethane, epoxy, acrylic, polyester resins, and the like), or an elastomer (e.g., acrylonitrile-styrene butadiene (ABS)), and mixtures thereof). The use of elastically deformable materials renders the pavement marker more resistant to cracking Core-shell housings may further comprise a number of ribs disposed in the interior of housing 10, as described, for example, in U.S. Pat. No. 6,126,360 (May).

In some embodiments, housing 10 includes a retroreflective element 60 that retroreflects incident light. Retroreflective element 60 may be, for example, a retroreflective lens and/or a piece of retroreflective material. Exemplary retroreflective lenses used in raised pavement markings include vacuum-metallized retroreflective lenses and totally-internal-reflective lenses. In some embodiments, retroreflective element 60 is integrally formed into or onto housing 10. Alternatively, retroreflective element 60 can be adhered to or positioned adjacent to housing 10 by, for example, mechanical means (e.g., one or more screws, nail, rivets, and/or gaskets), adhesive means (e.g., adhesives, adhesive tapes, and/or adhesive films including, for example, those described in, for example, U.S. Pat. Nos. 6,264,860, 6,551,014 (Khieu)), and welding (e.g., ultrasonic welding). The housing may be filled with a potting compound. Because the pavement markers sustain repeated vehicle impact, they tend to sustain a high rate of breakage and shattering. Thus the housing may include a high impact strength material, such as, for example, those described in U.S. Pat. No. 4,875,798 (May). Alternatively or in addition to the high strength material, the shell housing may be reinforced with fibers, such as, for example, those described in U.S. Pat. No. 5,340,231 (Steere, et al).

Retroreflective element 60 may be made from the same material as housing 10 or may be made of a different material. Retroreflective element 60 may be at least one of substantially transparent, dimensionally stable, durable, weatherable, rigid, flexible, and readily formable into a desired configuration. Any appropriate material can be used to form retroreflective element 60. Some exemplary materials include acrylic resins, (e.g., Plexiglas™ brand resin available from Rohm and Haas) and retroreflective sheeting (e.g., beaded and prismatic sheeting sold by 3M Company). In some embodiments, retroreflective element 60 may include an abrasion-resistant coating or an overlay to reduce damage or wear, such as, for example, those described in U.S. Pat. No. 5,677,050 (Bilkadi). Alternatively, retroreflective element 60 may include an easy-clean coating, such as, for example, those described in U.S. Publication No. 2005/0249940 (Klun).

Some embodiments of the internally illuminated pavement markers of the present disclosure are raised, wherein they are affixed to the roadway surface such that all or most of them sit atop the roadway surface. Alternatively, the internally illuminated pavement markers of the present disclosure may be inset into the roadway surface such that they are flush with or extend only minimally above the roadway surface. Raised or inset pavement markers can be attached to the roadway surface in any known way. For example, they can be adhered to an asphalt or concrete surface using a pressure sensitive adhesive (PSA), as described in, for example, U.S. Publication No. 2002/0004135 (Khieu) or U.S. Pat. No. 5,310,278 (Kaczmarczik). Alternatively, the internally illuminated pavement markers can be secured to the roadway surface by any known means including, for example, mechanical means (e.g., pins or studs) or adhesive means.

The recitation of all numerical ranges by endpoint is meant to include all numbers subsumed within the range (i.e., the range 1 to 10 includes, for example, 1, 1.5, 3.33, and 10).

Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims.

1. A self-illuminating pavement marker, comprising:
a light source capable of emitting light, the light source conductively coupled to a rechargeable electrical power source;
a solar energy system capable of collecting solar energy and converting the solar energy into electrical energy, the solar energy system including a solar cell and being conductively coupled to the rechargeable electrical power source such that the solar energy collected and converted into electrical energy recharges the rechargeable electrical power source;
an optical fiber capable of propagating the light emitted by the light source within the pavement marker by means of total internal reflection; and
a housing including at least one of the light source, the solar energy system, and the optical fiber, at least a portion of the housing being transparent such that ambient light can pass through the transparent portion of the housing and charge the solar cell and out of which the light emitted by the light source can propagate.

2. The self-illuminating pavement marker of claim 1, wherein the light source includes at least one LED.

3. The self-illuminating pavement marker of claim 2, wherein the light source is a single LED.

4. The self-illuminating pavement marker of claim 1, further including a retroreflective element.

5. The self-illuminating pavement marker of claim 1, wherein the solar energy system includes a circuit board containing a solar charging circuit, a light sensor circuit, and a light source driver circuit capable of applying power to the light source when the amount of ambient light falls below a predetermined threshold.

6. The self-illuminating pavement marker of claim 5, wherein the predetermined threshold is the point at which ambient light is insufficient to power the light source.

7. The self-illuminating pavement marker of claim 5, wherein the light source driver circuit is capable of using power from the light source to charge the rechargeable electrical power source when the ambient light exceeds the predetermined threshold.

8. The self-illuminating pavement marker of claim 1, wherein the housing includes detachable portions.

9. The self-illuminating pavement marker of claim 1, wherein the optical fiber has a light emitting region and includes a plurality of optical elements comprising optical quality reflecting surfaces that are arranged such that light propagating along the optical fiber impinges upon the optical quality reflecting surfaces.

10. The self-illuminating pavement marker of claim 9, wherein at least one of the optical quality reflecting surfaces has a cross-sectional area that is less than that of the optical fiber.

11. The self-illuminating pavement marker of claim 9, wherein the optical quality reflecting surfaces vary in at least one of cross-sectional area and spacing such that the light emitted at the light emitting region is substantially uniform.

12. A self-illuminating pavement marker, comprising:
a single LED capable of emitting light and connected to a power source;
an optical fiber capable of propagating the light emitted by the LED within the pavement marker by means of total internal reflection;
a retroreflective element; and
a housing within which are located at least one of the light source, the power source, and the optical fiber.

13. The self-illuminating pavement marker of claim 12, wherein the power source is a rechargeable electrical power source and further including:
a solar energy system capable of collecting solar energy and converting the solar energy into electrical energy, the solar energy system including a solar cell and being conductively coupled to the rechargeable electrical power source such that the solar energy collected and converted into electrical energy recharges the rechargeable electrical power source.

14. The self-illuminating pavement marker of claim 13, wherein the solar energy system includes a circuit board containing a solar charging circuit, a light sensor circuit, and a light source driver circuit capable of applying power to the light source when the amount of ambient light falls below a predetermined threshold.

15. The self-illuminating pavement marker of claim 14, wherein the predetermined threshold is the point at which ambient light is insufficient to power the light source.

16. The self-illuminating pavement marker of claim 14, wherein the light source driver circuit is capable of using power from the light source to charge the rechargeable electrical power source when the ambient light exceeds the predetermined threshold.

17. The self-illuminating pavement marker of claim 12, wherein the housing includes detachable portions.

18. The self-illuminating pavement marker of claim 12, wherein the optical fiber has a light emitting region and includes a plurality of optical elements comprising optical quality reflecting surfaces that are arranged such that light propagating along the optical fiber impinges upon the optical quality reflecting surfaces.

19. The self-illuminating pavement marker of claim 18, wherein at least one of the optical quality reflecting surfaces has a cross-sectional area that is less than that of the optical fiber.

20. The self-illuminating pavement marker of claim 18, wherein the optical quality reflecting surfaces vary in at least one of cross-sectional area and spacing such that the light emitted at the light emitting region is substantially uniform.

21. The self-illuminating pavement marker of claim 12, further comprising a shank attached to at least one side of a bottom shell portion.
